(19) United States
(12) Patent Application Publication
(10) Pub. No.: US 2025/0045691 A1
(43) Pub. Date: Feb. 6, 2025

(54) INVENTORY OPTIMIZATION DEVICE AND INVENTORY OPTIMIZATION METHOD

(71) Applicants: Digiwin Software Co., Ltd, Shanghai (CN); DATA SYSTEMS CONSULTING CO., LTD., New Taipei City (TW)

(72) Inventors: Li Zhuang, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/480,509

(22) Filed: Oct. 4, 2023

(30) Foreign Application Priority Data
Jul. 31, 2023 (CN) 202310952613.4

(51) Int. Cl. G06Q 10/087

(52) U.S. Cl. CPC G06Q 10/087

(57) ABSTRACT

An inventory optimization device and an inventory optimization method are provided. The inventory optimization device includes a memory and a processor. The processor executes a plurality of modules in the memory such that the plurality of modules execute genetic programming according to business data from an enterprise database to generate an objective function. The plurality of modules calculate the objective function according to an adjustment instruction from an electronic device to generate a fitness function. The plurality of modules execute a genetic algorithm according to the fitness function to generate a recommendation result, so that the electronic device manages the enterprise database according to the recommendation result, so as to improve operation efficiency of managing inventory.

### CROSS-REFERENCE TO RELATED APPLICATION

This application claims the priority benefit of China application serial no. 202310952613.4, filed on Jul. 31, 2023. The entirety of the above-mentioned patent application is hereby incorporated by reference herein and made a part of this specification.

### BACKGROUND

### Technical Field

The disclosure relates to an inventory management device, and particularly relates to an inventory optimization device and inventory optimization method.

### Description of Related Art

An enterprise may manage inventory through an inventory management device to assist operation of a supply chain. However, since the conventional inventory management device performs a prediction operation based on historical demand data to recommend an inventory management solution, the recommended solution cannot reflect a future demand. In addition, due to the inaccurate recommendation result mentioned above, the inventory may be over-loaded or under-loaded, which may affect the operation of the supply chain. On the other hand, a user still needs to manually operate the conventional inventory management device to manage inventory through operations such as ordering, allocation, stock check, etc. Therefore, the conventional inventory management device consumes a lot of human resources and operating time and reduces operation efficiency.

### SUMMARY

The disclosure is directed to an inventory optimization device, which is adapted to intelligently and automatically provide an accurate recommendation result, so as to improve operation efficiency of managing inventory.

According to an embodiment of the disclosure, the inventory optimization device of the disclosure includes a memory and a processor. The memory stores a plurality of modules. The processor is coupled to the memory, an enterprise database, and an electronic device. The processor executes the plurality of modules such that the plurality of modules execute genetic programming according to business data from the enterprise database to generate an objective function. The plurality of modules calculate the objective function according to an adjustment instruction from the electronic device to generate a fitness function. The plurality of modules execute a genetic algorithm according to the fitness function to generate a recommendation result, so that electronic device manages the enterprise database according to the recommendation result.

According to an embodiment of the disclosure, the inventory optimization method of the disclosure uses a processor to execute a plurality of modules in the memory, and includes the following steps. Genetic programming is executed by the plurality of modules according to business data from an enterprise database to generate an objective function. The objective function is calculated by the plurality of modules according to an adjustment instruction from an electronic device to generate a fitness function. A genetic algorithm is executed by the plurality of modules according to the fitness function to generate a recommendation result, so that the electronic device manages the enterprise database according to the recommendation result.

Based on the above description, the inventory optimization device and inventory optimization method of the disclosure execute genetic programming to assist generating a fitness function, and further execute a genetic algorithm to generate a recommendation result, which may consider actual application situations of an enterprise and optimize the recommendation result accordingly. Therefore, the inventory optimization device may intelligently and automatically provide the accurate recommendation result by combining the genetic programming and the genetic algorithm, and may improve operation efficiency of managing inventory.

To make the aforementioned more comprehensible, several embodiments accompanied with drawings are described in detail as follows.

### BRIEF DESCRIPTION OF THE DRAWINGS

FIG. 1 is a circuit block diagram of an inventory optimization device according to an embodiment of the disclosure.

FIG. 2 is a flowchart of an inventory optimization method according to an embodiment of the disclosure.

FIG. 3 is a schematic structural diagram of an inventory optimization device according to an embodiment of the disclosure.

FIG. 4 is a flowchart of an inventory optimization method of the embodiment of FIG. 3.

FIG. 5 is a flowchart of an inventory optimization method according to another embodiment of the disclosure.

FIG. 6 is an operational schematic diagram associated with genetic programming of the embodiment of FIG. 5.

FIG. 7 is an operational schematic diagram associated with genetic programming of the embodiment of FIG. 5.

FIG. 8 is an operational flowchart associated with a genetic algorithm of the embodiment of FIG. 5.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

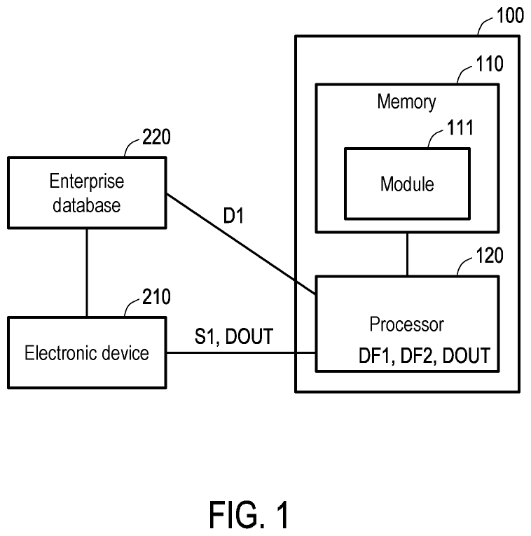

FIG. 1 is a circuit block diagram of an inventory optimization device according to an embodiment of the disclosure. Referring to FIG. 1, an inventory optimization device 100 applies data-driven programming. The inventory optimization device 100 automatically provides a solution for handling inventory (i.e., a recommendation result DOUT) according to business data D1. The recommendation result DOUT may include one or a plurality of inventory recommendation values (for example, weight coefficients) to serve as indicators for inventory optimization. In this way, the inventory optimization device 100 may update relevant inventory recommendation values in real time through data-driven programming, thereby improving inventory management capabilities and operating efficiency. In the embodiment, the inventory optimization device 100 may include a memory 110 and a processor 120. The processor 120 is coupled to the memory 110, an electronic device 210 and an enterprise database 220.

In the embodiment, a user may operate the electronic device 210 to call the inventory optimization device 100 through an application programming interface (API). The user may also operate the electronic device 210 to call an enterprise system through the API, and then execute various business services based on the enterprise database 220 through the enterprise system. The electronic device 210 may be, for example, a mobile phone, a tablet computer, a notebook computer, a desktop computer, etc. The enterprise system may be, for example, an enterprise resource planning (ERP) system (an ERP system is taken as an example for description hereinafter). The enterprise database 220 may be, for example, a database that stores various data associated with the ERP system (such as data associated with inventory).

In the embodiment, the inventory optimization device 100 may be set in the cloud for the user to connect through the electronic device 210 to execute the inventory optimization device 100. The inventory optimization device 100 may be, for example, a software as a service (SaaS) server, so as to execute corresponding an SaaS application through the API. In some embodiments, the inventory optimization device 100 may be installed on the ground in the enterprise, so that the user may connect the inventory optimization device 100 to other systems installed in the cloud through the electronic device 210 to input/output data, so as to execute the corresponding SaaS application through the API.

In the embodiment, the memory 110 stores a plurality of modules 111. In the embodiment, the memory 110 may also store related algorithms, programs and data such as computing software, etc., for realizing data mining, genetic programming, genetic algorithm, model training, and various computing functions of the disclosure. The memory 110 may be, for example, a dynamic random access memory (DRAM), a flash memory, a non-volatile random access memory (NVRAM) or a combination of these memories.

In the embodiment, the processor 120 accesses the memory 110 and may execute data and the plurality of modules 111 in the memory 110. The processor 120 also accesses an adjustment instruction S1 from the electronic device 210 and the business data D1 from the enterprise database 220. In the embodiment, the processor 120 may be, for example, a signal converter, a field programmable gate array (FPGA), a central processing unit (CPU), or other programmable general-purpose or special purpose microprocessor, digital signal processor (DSP), programmable controller, application specific integrated circuit (ASIC), programmable logic device (PLD) or other similar devices or combinations of these devices, which may load and execute computer program-related firmware or software to realize functions such as data mining, genetic programming, genetic algorithm, model training, and various calculations.

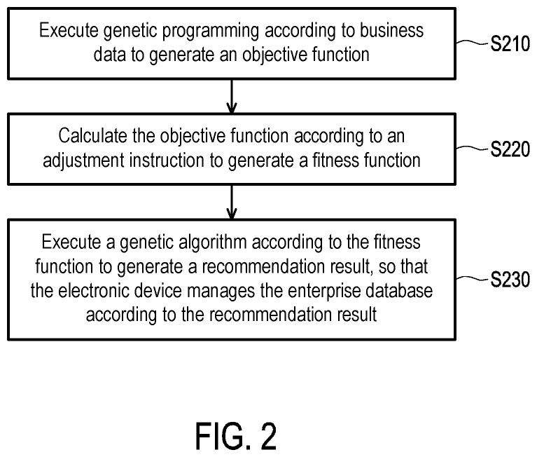

FIG. 2 is a flowchart of an inventory optimization method according to an embodiment of the disclosure. Referring to FIG. 1 and FIG. 2, the inventory optimization device 100 may execute steps S210-S230. The order of these steps S210-S230 is only an example for illustration, and the disclosure is not limited thereto. In the embodiment, the processor 120 executes the plurality of modules 111 to implement the inventory optimization method.

In step S210, the processor 120 executes the plurality of modules 111, so that the plurality of modules 111 execute genetic programming (GP) according to the business data D1 from the enterprise database 220 to generate the objective function DF1. In the embodiment, the business data D1 may be, for example, inventory data associated with an ERP system. The business data D1 may, for example, include inventory data such as purchase cost, inventory storage time, and transportation cost of a certain commodity. In the embodiment, the objective function DF1 may be, for example, tree structure data to represent a relationship between the business data D1 as an independent variable and a dependent variable.

Namely, the processor 120 applies an evolutionary algorithm (EA) and machine learning (i.e., genetic programming) to transform the business data D1 into one or a plurality of independent variables and dependent variables, and constructs the tree structure data associated with the business data D1 (i.e., the objective function DF1).

In step S220, the processor 120 executes the plurality of modules 111, so that the plurality of modules 111 calculate the objective function DF1 according to the adjustment instruction S1 from the electronic device 210 to generate a fitness function DF2. In the embodiment, the adjustment instruction S1 may be, for example, an instruction generated by the user operating the inventory optimization device 100 to interactively calculate and determine a weight coefficient of the objective function DF1 with the inventory optimization device 100, so as to generate the fitness function DF2. In the embodiment, the fitness function DF2 may be, for example, an integrated function of the objective function DF1 based on various weight coefficients, so as to indicate an evaluation strategy for integrating various objective functions DF1.

In step S230, the processor 120 executes the plurality of modules 111, so that the plurality of modules 111 execute a genetic algorithm (GA) according to the fitness function DF2 to generate a recommendation result DOUT, and the electronic device 210 manages the enterprise database 220 according to the recommendation result DOUT. In the embodiment, the recommendation result DOUT may be, for example, an optimization solution based on the genetic algorithm to indicate an inventory strategy based on a certain combination of considerations. In the embodiment, the genetic algorithm may also be referred to as an inherited algorithm.

Namely, the processor 120 applies the evolutionary algorithm to find the optimal solution of the fitness function DF2 (i.e., the recommendation result DOUT). The user operates the electronic device 210 to access the recommendation result DOUT, and realize inventory optimization accordingly.

It should be noted that the inventory optimization device 100 combines genetic programming and genetic algorithm. By executing genetic programming, the inventory optimization device 100 may assist in generating the fitness function DF2. Further, by executing the genetic algorithm, the inventory optimization device 100 may generate the optimal inventory solution (i.e., the recommendation result DOUT). In this way, the inventory optimization device 100 may consider an actual application situation (i.e., the business data D1) of the enterprise database 220, and may combine the aforementioned two algorithms to intelligently and automatically provide the accurate recommendation result DOUT, thereby improving operation efficiency of managing the enterprise database 220.

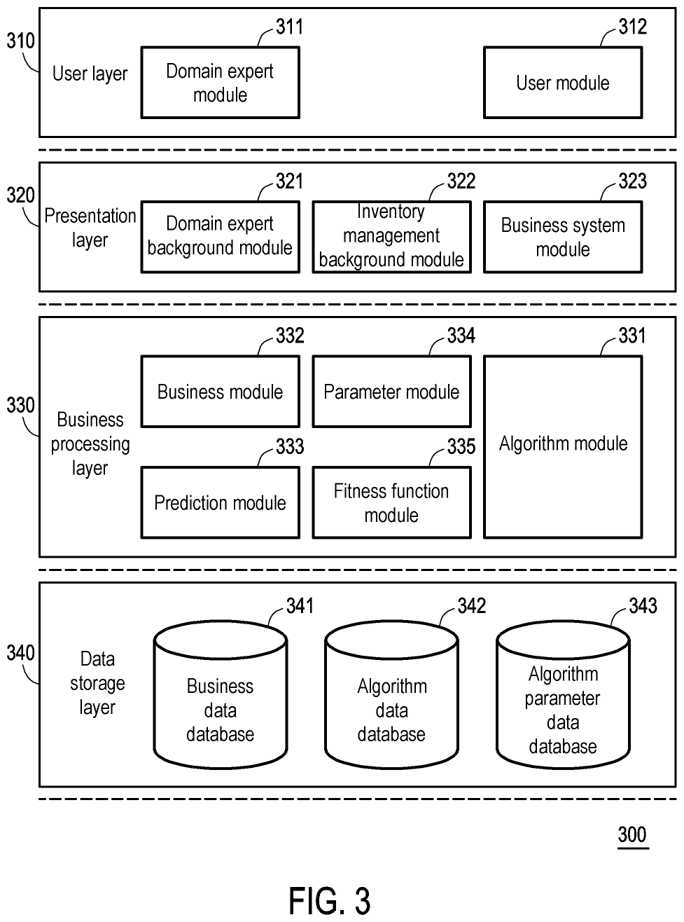

FIG. 3 is a schematic structural diagram of an inventory optimization device according to an embodiment of the disclosure. Referring to FIG. 3, the inventory optimization device 300 may include a memory and a processor (not shown), and may be deduced by referring to relevant descriptions of the inventory optimization device 100. In the embodiment, the inventory optimization device 300 may be implemented, for example, with a layered framework. The layered framework may, for example, include a user layer 310, a presentation layer 320, a business processing layer 330, and a data storage layer 340. The layers 310-340 respectively include a plurality of modules 311-343 to respectively realize various corresponding functions. These modules 311-343 may be, for example, implementation details of the plurality of modules 111 shown in FIG. 1.

In the embodiment, the user layer 310 provides multiple users with access to the inventory optimization device 300. The user layer 310 may include a domain expert module 311 and a user module 312. In the embodiment, a first user (such as a production manager) operates the inventory optimization device 300 through the domain expert module 311 to intelligently implement inventory optimization and inventory management interactively with the inventory optimization device 300. A second user (for example, a general employee) operates the inventory optimization device 300 through the user module 312 to access the recommendation result DOUT.

In the embodiment, the presentation layer 320 processes a communication logic between the user layer 310 and a web browser. The presentation layer 320 may include a domain expert background module 321, an inventory management background module 322, and a business system module 323. In the embodiment, the domain expert background module 321 processes a communication logic associated with the domain expert module 311. The inventory management background module 322 processes a communication logic associated with the user module 312. The business system module 323 processes a communication logic associated with the enterprise database 220 shown in FIG. 1.

In the embodiment, the business processing layer 330 processes a business logic of software in the inventory optimization device 300. The business processing layer 330 may include an algorithm module 331, a business module 332, a prediction module 333, a parameter module 334, and a fitness function module 335. In the embodiment, these modules 331-335 process business logics to implement the inventory optimization method.

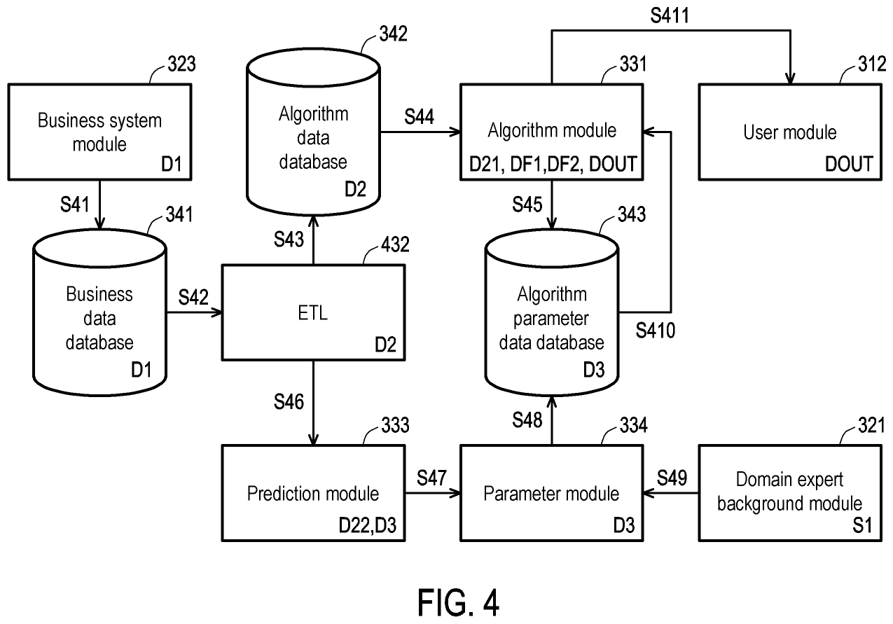

Specifically, the business module 332 is configured to provide various business data (such as business data D1 shown in FIG. 4) through the business system module 323 to increase accuracy of each module 331-335 in the business processing layer 330. In addition, the business module 332 is configured to interoperate with the user through the domain expert background module 321.

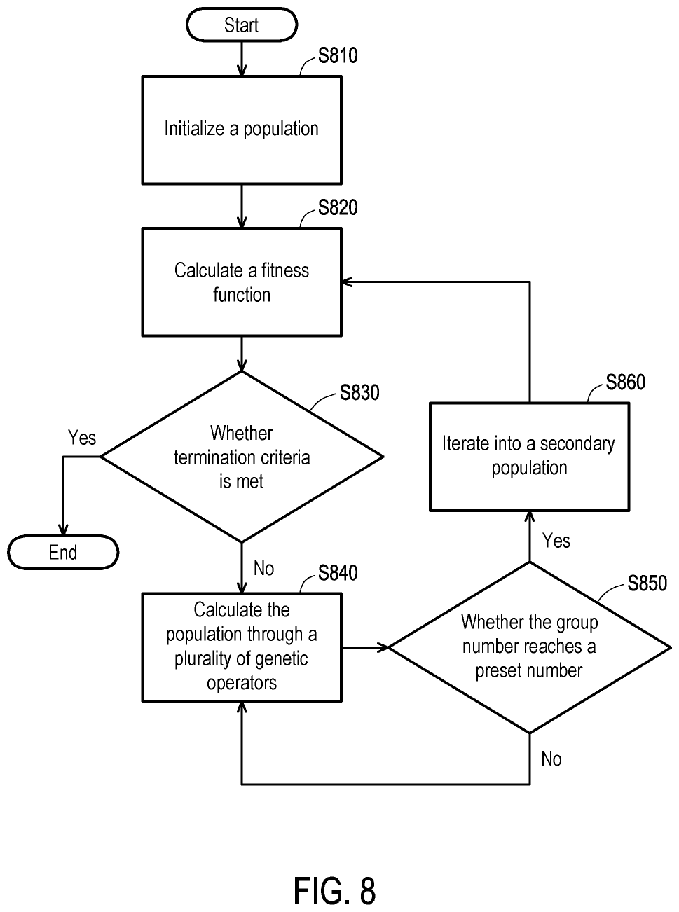

In the embodiment, the prediction module 333 is configured to execute a trained prediction model to realize a prediction operation. In the embodiment, the aforementioned prediction model may include a support vector machine (SVM) and a neural network that implements corresponding functions. For example, the prediction module 333 performs prediction according to input parameter data D22 (such as an inflation rate) as shown in FIG. 4 to generate parameter data D3 as shown in FIG. 4, so as to assist in generating the fitness function DF2 shown in FIG. 4. The aforementioned parameter data D3 may be, for example, a prediction objective function generated in step S820 as shown in FIG. 8 to serve as a prediction result. For another example, the prediction module 333 performs prediction according to the input parameter data D22 (such as probability distribution of historical data) as shown in FIG. 4 to initialize a population required by the genetic algorithm, thereby assisting the operation of the genetic algorithm. The aforementioned population may be, for example, an initial population generated in step S810 as shown in FIG. 8.

In the embodiment, the parameter module 334 is configured to provide an API, and configured to access data related to the genetic algorithm (for example, the parameter data D3 shown in FIG. 4). In the embodiment, the fitness function module 335 is configured to provide an API, and configured to access the objective function DF1 and the fitness function DF2 as shown in FIG. 4.

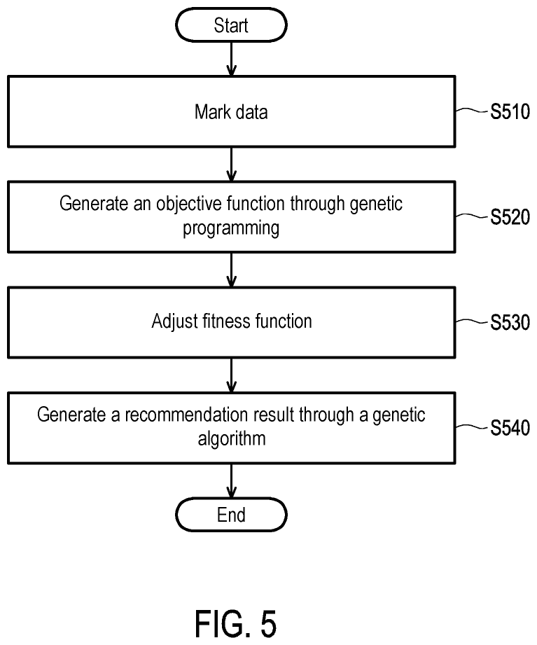

In the embodiment, the algorithm module 331 serves as a core for implementing the inventory optimization method, and includes a genetic programming sub-module (not shown) and a genetic algorithm sub-module (not shown). The genetic programming sub-module is configured to execute genetic programming according to the operation data to generate the objective function (the objective function DF1 shown in FIG. 4). The aforementioned operation data may be, for example, algorithm data D21 calculated in step S44 of FIG. 4, or marked data calculated in step S520 of FIG. 5.

Continuing the above description, the genetic algorithm sub-module is configured to update the fitness function (the fitness function DF2 shown in FIG. 4) according to the initial population generated by the prediction module 333 through the parameter data generated by the prediction module 333 (the parameter data D3 as shown in FIG. 4, or the prediction objective function in step S820). The genetic algorithm sub-module is configured to execute the genetic algorithm according to the fitness function to generate inventory optimization result (the recommended result DOUT shown in FIG. 4).

In addition, the algorithm module 331 is configured to call the fitness function module 335 to CRUD the objective function DF1 and the fitness function DF2 as shown in FIG. 4. The operation of CRUD includes a series of operations such as create, delete, read, and update. The algorithm module 331 is also configured to call the parameter module 334 to CRUD the prediction objective function generated in step S820 of FIG. 8, and the initial population generated in step S810 of FIG. 8.

In the embodiment, the data storage layer 340 stores various data. The data storage layer 340 may include a business data database 341, an algorithm data database 342, and an algorithm parameter data database 343.

FIG. 4 is a flowchart of the inventory optimization method of the embodiment of FIG. 3. Referring to FIG. 3 and FIG. 4, the inventory optimization device 300 may execute steps S41 to S411 to illustrate a data flow process of the inventory optimization device 300. The order of these steps S41-S411 is only an example for illustration, and the disclosure is not limited thereto. In the embodiment, the processor of the inventory optimization device 300 executes the plurality of modules 311-343 to implement the inventory optimization method.

In the embodiment, the processor executes steps S41-S45 to generate the objective function DF1 based on genetic programming, to illustrate implementation details of step S210. In detail, in step S41, the processor executes the business system module 323, and the business system module 323 accesses the business data D1 from the enterprise database 220 shown in FIG. 1 to generate the business data D1 accordingly. The processor executes the business system module 323, and the business system module 323 writes the business data D1 into the business data database 341.

In step S42, the processor executes the business module 332, and the business module 332 accesses the business data D1 in the business data database 341, and performs a pre-processing operation on the business data D1 to generate operation data D2. In the embodiment, the pre-processing operation may include executing an ETL component 432 to extract, transform and load the business data D1 to generate data corresponding to the evolutionary algorithm. The pre-processing operation may also include data cleaning to replace, modify, or delete dirty data in the aforementioned data to generate the operation data D2.

In step S43, the processor executes the business module 332, and the business module 332 stores the operation data D2 into the algorithm data database 342 to access the algorithm data database 342. In detail, the business module 332 writes the operation data D2 into the algorithm data database 342 through the ETL component 432.

In step S44, the processor executes the algorithm module 331, so that the algorithm module 331 accesses the algorithm data database 342 to obtain the operation data D2, so as to access the algorithm data database 342. In addition, the processor executes the algorithm module 331, and the algorithm module 331 executes genetic programming according to the algorithm data D21 associated with the genetic programming in the operation data D2 to generate the objective function DF1. In the embodiment, the algorithm data D21 may be, for example, data required when executing genetic programming.

In step S45, the processor executes the algorithm module 331, and the algorithm module 331 stores (i.e., writes) the objective function DF1 into the algorithm parameter data database 343 to access the algorithm parameter data database 343.

In the embodiment, the processor executes steps S45-S410 to generate the fitness function DF2 based on interoperations between the prediction module 333, the algorithm module 331 and the domain expert background module 321, to illustrate implementation details of step S220.

In detail, in step S46, the processor executes the prediction module 333, and the prediction module 333 accesses the algorithm data database 342 to obtain the operation data D2, and performs a prediction operation according to the input parameter data D22 associated with the enterprise database 220 of FIG. 1 in the operation data D2 to generate the parameter data D3. Specifically, the prediction module 333 reads the algorithm data database 342 through the ETL component 432 to obtain the input parameter data D22. The prediction module 333 executes the trained prediction model on the input parameter data D22 to realize a prediction operation, and generates the parameter data D3 accordingly.

In the embodiment, the input parameter data D22 associated with the enterprise database 220 may be, for example, various input parameters input by operating the enterprise database 220, i.e., various external factors that may affect inventory. In the embodiment, the parameter data D3 may be, for example, various other factors (such as an inflation rate) that affect the inventory of the enterprise database 220.

In step S47, the processor executes the prediction module 333, and the prediction module 333 provides (for example, temporarily stores) the parameter data D3 to the parameter module 334. In step S48, the processor executes the parameter module 334, and the parameter module 334 stores (i.e., writes) the parameter data D3 into the algorithm parameter data database 343 to access the algorithm parameter data database 343.

In step S49, the processor executes the domain expert background module 321, and the domain expert background module 321 accesses the adjustment instruction S1 from the electronic device 210 shown in FIG. 1, and adjusts the parameter associated with the objective function DF1 according to the adjustment instruction S1. In detail, the domain expert background module 321 adds, modifies, or deletes the parameter (such as a function weight) associated with the objective function DF1 according to the adjustment instruction S1, and provides (for example, temporarily stores) the adjusted parameter as a part of the parameter data D3 to the parameter module 334. In the embodiment, the parameter module 334 repeatedly executes step S48 to write the updated parameter data D3 into the algorithm parameter data database 343.

It should be noted that, based on step S46, by performing the prediction operation on the dynamic input parameter data D22 by the prediction module 333, the parameter data D3 serving as an input of the fitness function DF2 may be provided. In this way, the prediction module 333 is able to influence an inventory strategy in response to a current change. On the other hand, based on step S44 and step S49, through the interactive operation of the domain expert background module 321 and the algorithm module 331, the parameter data D3 (for example, a function weight) may be adaptively adjusted according to a situation of the enterprise. In this way, the inventory optimization device 100 may influence the inventory strategy in response to various enterprise strategies.

In step S410, the processor executes the algorithm module 331, and the algorithm module 331 accesses the algorithm parameter data database 343 to obtain the parameter data D3. In addition, based on the adjustment instruction S1, the algorithm module 331 calculates (for example, replaces or recalculates) the objective function DF1 in step S44 according to the parameter (for example, the function weight) in the parameter data D3 to generate the fitness function DF2.

In the embodiment, the processor executes steps S410-S411 to generate and push the recommendation result DOUT based on the genetic algorithm, to illustrate implementation details of step S230. In detail, returning to step S410, the processor executes the algorithm module 331, and the algorithm module 331 executes the genetic algorithm according to the fitness function DF2 to generate the recommendation result DOUT. Namely, the algorithm module 331 continuously optimizes the fitness function DF2 to use an optimized iterative result as the recommendation result DOUT.

In step S411, the processor executes the business module 332 and the user module 312, and the business module 332 outputs the recommendation result DOUT to the user interface of the electronic device 210 shown in FIG. 1 through the user module 312. The electronic device 210 accesses and displays the recommendation result DOUT. Accordingly, the user operates the electronic device 210 to manage the enterprise database 220 shown in FIG. 1 based on the recommendation result DOUT.

FIG. 5 is a flowchart of an inventory optimization method according to another embodiment of the disclosure. Referring to FIG. 1 and FIG. 5, the inventory optimization device 100 may execute steps S510-S540. The order of these steps S510-S540 is only for illustration and the disclosure is not limited thereto. In the embodiment, the processor 120 executes the plurality of modules 111 to implement the inventory optimization method.

In the embodiment, the processor 120 executes steps S510-S520 to generate the objective function DF1 based on genetic programming, to illustrate implementation details of step S210 and steps S41-S45.

In detail, in step S510, the processor 120 executes a plurality of modules 111 (such as the domain expert background module 321 shown in FIG. 3), and the domain expert background module 321 accesses the adjustment instruction S1 from the electronic device 210, and marks the data used for genetic programming according to the adjustment instruction S1 to generate data such as an independent variable, a dependent variable, etc., associated with the business data D1. The independent variable may be, for example, a variable denoted by “A”, “B” and “C”, and the dependent variable may be, for example, a variable denoted by “Y”.

Namely, the user may operate the electronic device 210 to manually mark the independent variable and the dependent variable associated with the business data D1 through the domain expert background module 321. In the embodiment, the aforementioned independent variable and dependent variable may be used as the algorithm data (for example, the algorithm data D21 shown in FIG. 4) associated with genetic programming in the operation data D2, so as to be calculated through genetic programming in the subsequent step S520.

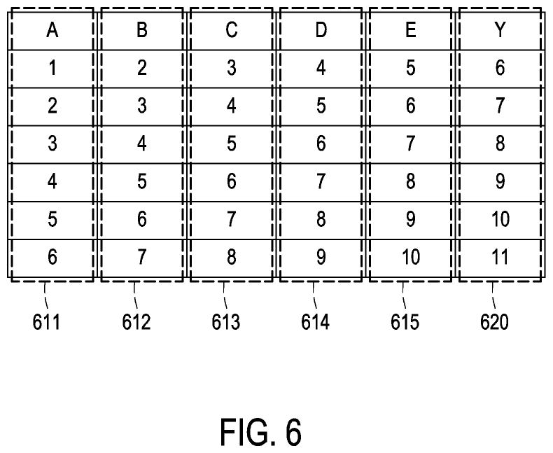

Referring to FIG. 6 together, FIG. 6 is an operational schematic diagram associated with genetic programming of the embodiment of FIG. 5. The data marked in step S510 may include a plurality of independent variables and a dependent variable. These independent variables may include a plurality of variables represented by “A” to “E”, and are presented in a plurality of fields 611-615 respectively. These independent variables respectively indicate a plurality of factors that may affect the business data D1. In the embodiment, the dependent variable may include a variable denoted by “Y” and is presented in a field 620. The dependent variable indicates an outcome factor of integrating the various independent variables.

In step S520, the processor 120 executes a plurality of modules 111 (such as the algorithm module 331 shown in FIG. 3), and the algorithm module 331 calculates the marked data through genetic programming to generate the objective function DF1. Namely, the algorithm module 331 randomly constructs an initial population of genetic programming according to a variable set marked in step S510, and evolves various objective functions DF1 based on an evolution method (such as a grow method and/or a full method). The objective function DF1 may be, for example, a function set represented by “A+B*C=Y”.

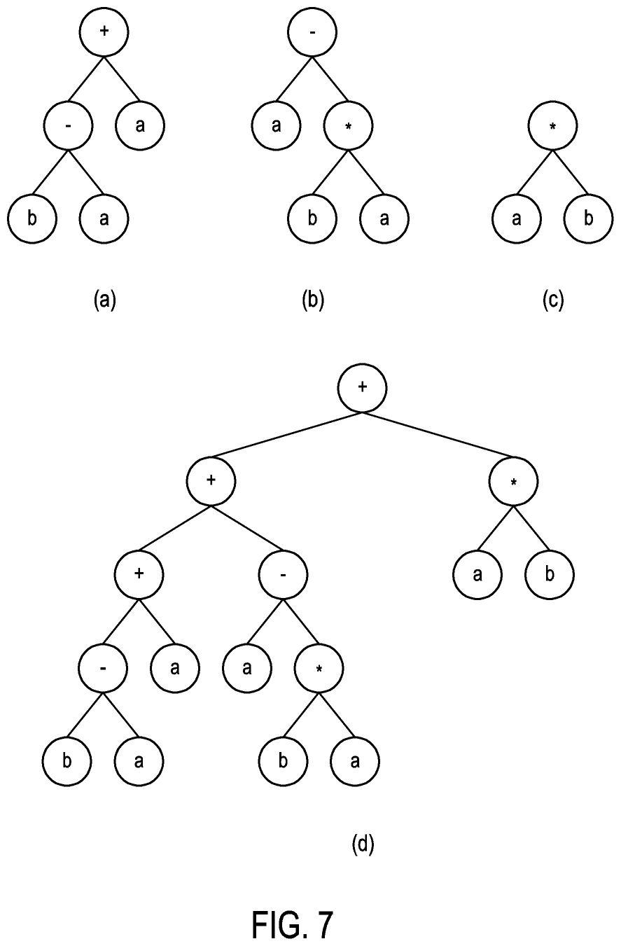

Referring to FIG. 7 together, FIG. 7 is an operational schematic diagram associated with genetic programming of the embodiment of FIG. 5. Each objective function DF1 generated in step S520 may be, for example, tree structure data, so as to be combined into a function set through leaf nodes and internal nodes. For example, in the objective function DF1 shown in “(b)”, the objective function DF1 may include a plurality of leaf nodes represented by “a”, a leaf node represented by “b”, an internal node represented by “*”, and an internal node represented by “-”. The leaf nodes represented by “a” and the leaf node represented by “b” may be, for example, respectively an independent variable represented by “A” and an independent variable represented by “B” in FIG. 6. In this way, the objective function DF1 may be, for example, a function set represented by “A+B*C=Y”.

For example, a calculation formula associated with procurement costs may include various first cost factors, and may be represented by the objective function DF1. The aforementioned first cost factors may, for example, include cost data such as a product price, transportation charges, tariff and tax, storage cost, quality inspection cost, and other costs. The product price indicates a cost price of the product and may include volume discounts as well as other transaction costs. The transportation charges indicate transportation cost of the products and may include a transportation fee, an insurance fee, etc. The tariff and tax indicate tariffs and other taxes that need to be paid on imported products. The storage cost indicate charges for warehouse storage, and safekeeping of the products. The quality inspection cost indicates a charge for quality inspection of the purchased products. The other costs indicate other procurement-related expenses and may include procurement staff salaries, travel expenses, etc.

Continuing with the above example, the domain expert background module 321 marks the first cost factors according to the adjustment instruction S1 to serve as the marked data in step S520 (for example, the algorithm data D21 shown in FIG. 4). The algorithm module 331 executes genetic programming according to these first cost factors to generate a calculation equation of the procurement cost (i.e., the objective function DF1 associated with the procurement cost). Namely, the inventory optimization device 100 may adjust various cost factors of the procurement cost according to specific conditions of various enterprises, and automatically generate corresponding calculation equations.

In the embodiment, the processor 120 executes step S530 to generate the fitness function DF2 based on interoperation, to illustrate implementation details of step S220 and steps S44-S410.

In detail, in step S530, the processor 120 executes the plurality of modules 111 (for example, the domain expert background module 321 and the algorithm module 331 shown in FIG. 3), and the algorithm module 331 accesses the adjustment instruction S1 from the electronic device 210 through the domain expert background module 321, and calculates the objective function DF1 in step S520 according to the adjustment instruction S1 to adjust the fitness function DF2. Namely, the user may operate the electronic device 210 to manually adjust the combination of various objective functions DF1 through the domain expert background module 321 to obtain the fitness function DF2. The fitness function DF2 may be, for example, a function set represented by “A*X−B*Y=Z”.

For example, the calculation equation associated with the inventory cost may include various second cost factors, and may be represented by the fitness function DF2. The aforementioned second cost factors may, for example, include an inventory level, an inventory turnover rate, an inventory storage time, and procurement cost. The inventory level indicates efficiency and level of inventory management of the enterprise database 220, and is an important indicator of inventory management. The lower the inventory level is, the lower the inventory cost is. The inventory turnover rate is defined as the cost of sales divided by an average inventory amount, and indicates utilization efficiency of inventory. The higher the inventory turnover rate is, the faster an inventory turnover speed is and the lower the inventory cost is. The inventory storage time indicates a storage time of a material or a product. The longer the inventory storage time is, the higher the inventory cost is. The procurement cost is defined as cost of purchasing materials from suppliers by the ERP system.

Continuing with the above example, the algorithm module 331 designs a function (i.e., the fitness function DF2) for evaluating the pros and cons of different inventory strategies according to the adjustment instruction S1. The fitness function DF2 may comprehensively consider the aforementioned second cost factors, and may be implemented, for example, by a following equation (1):

Fitness=α*(1−inventory level)+β*(inventory turnover rate)+γ*(1−inventory storage time)+8*procurement cost equation (1)

In the equation (1), α, β, γ, and δ are weight coefficients. The adjustment instruction S1 may indicate respective values of these weight coefficients, or may indicate respective priorities or relationships of these weight coefficients so that the algorithm module 331 generates the corresponding weight value accordingly.

In the embodiment, the processor 120 executes step S530 to generate a recommendation result DOUT based on the genetic algorithm, to illustrate implementation details of step S230 and steps S410-S411.

In step S540, the processor 120 executes the plurality of modules 111 (for example, the algorithm module 331 shown in FIG. 3), and the algorithm module 331 calculates the fitness function DF2 through the genetic algorithm to generate the recommendation result DOUT. Namely, the fitness function DF2 may be used as an input parameter of the genetic algorithm. The algorithm module 331 optimizes the fitness function DF2 generated in step S530 (for example, each weight coefficient in the equation (1)) through the genetic algorithm, so as to obtain the optimal inventory strategy to serve as the recommendation result DOUT. The recommendation result DOUT may be, for example, weight coefficients represented by “A”, “B” and “C”.

FIG. 8 is an operational flowchart associated with the genetic algorithm of the embodiment of FIG. 5. Referring to FIG. 1 and FIG. 8, the inventory optimization device 100 may execute steps S810-S860. The order of these steps S810-S860 is only for illustration and the disclosure is not limited thereto. In the embodiment, the processor 120 executes the plurality of modules 111 to implement the method related to the genetic algorithm in step S540.

In step S810, the processor 120 executes the plurality of modules 111 (such as the algorithm module 331 or the prediction module 333 shown in FIG. 3), and the algorithm module 331 or the prediction module 333 initializes a population according to the input parameter data (for example, the input parameter data D22 shown in FIG. 3) associated with the enterprise database 220. In the embodiment, the inventory optimization device 100 may perform the aforementioned initialization operation based on multiple strategies.

For example, in a first strategy, in the embodiment, the processor 120 executes the prediction module 333, and the prediction module 333 performs a prediction operation according to the input parameter data D22 to generate an initial population. For example, for some inventory products in the enterprise database 220 that are greatly affected by external factors, the prediction module 333 executes a trained prediction model according to a probability distribution of historical data (i.e., the input parameter data D22) of the corresponding multiple external factors, so as to predict the inventory level under the influence of various external factors (such as an inflation rate), and initialize the population based on the prediction model.

For example, in a second strategy, in some embodiments, the processor 120 executes the algorithm module 331, and the algorithm module 331 calculates a Gaussian distribution result of the input parameter data D22, so as to randomly initialize the population based on the Gaussian distribution result. Alternatively, for example, in a third strategy, the processor 120 executes the algorithm module 331, and the algorithm module 331 obtains data related to quantity and type of the existing inventory in the input parameter data D22, so as to initialize the population based on prior knowledge to reduce the algorithm module 331 searching data and speeds up the process of the genetic algorithm.

It should be noted that by using the prediction module 333 to initialize the population with the prediction operation of big data, a convergence process of the genetic algorithm may be accelerated, thereby saving computing resources of the inventory optimization device 100.

In step S820, the processor 120 executes the plurality of modules 111 (such as the algorithm module 331 and the prediction module 333 shown in FIG. 3), and the algorithm module 331 and the prediction module 333 generate the fitness function DF2 according to the input parameter data (for example, the input parameter data D22 shown in FIG. 3) associated with the enterprise database 220, and calculate the fitness function DF2 to generate a corresponding fitness value. Step S820 may be, for example, another implementation detail of step S220 or S410.

In detail, the processor 120 executes the prediction module 333, and the prediction module 333 performs a prediction operation according to the input parameter data D22 to generate a predicted objective function. The predicted objective function may be, for example, the parameter data D3 shown in FIG. 3. For example, for certain inventory products in the enterprise database 220 that are greatly affected by future trends, the prediction module 333 executes the trained prediction model according to the corresponding plurality of external factors (i.e., the input parameter data D22) to predict one or a plurality of parameters related to changes in the future to serve as calculation factors for a new objective function DF1 (i.e., the predicted objective function).

Following the above description, the processor 120 executes the algorithm module 331, and the algorithm module 331 calculates the predicted objective function according to the parameter data (for example, the parameter data D3 shown in FIG. 3) to update the fitness function DF2. Namely, based on the predicted objective function added by the prediction operation, the algorithm module 331 may completely calculate the fitness function DF2 adapted to a current change to serve as a possible inventory strategy. Then, the algorithm module 331 calculates the current fitness function DF2 to generate a corresponding fitness value. The fitness value may be used as a comparison basis of a termination criteria to indicate whether the corresponding fitness function DF2 is the best solution.

In the embodiment, the processor 120 executes steps S830-S860 to calculate the initial population according to the fitness function DF2 through the algorithm module 331 shown in FIG. 3 so that the initial population may be iterated into a secondary population. In addition, the algorithm module 33 obtains the recommendation result DOUT from a certain secondary population according to the satisfied termination criteria (for example, an objective fitness value corresponding to the fitness function DF2), and ends execution of the genetic algorithm.

In detail, in step S830, the processor 120 executes the plurality of modules 111 (for example, the algorithm module 331 shown in FIG. 3), and the algorithm module 331 determines whether the current population meets the termination criteria. When the current population meets the termination criteria, it means that the algorithm module 331 has found the optimal fitness function DF2, and the algorithm module 331 outputs the fitness function DF2 as the recommendation result DOUT.

On the other hand, when the current population does not meet the termination criteria, it means that the algorithm module 331 has not found the optimal fitness function DF2. At this time, the processor 120 executes step S840. In step S840, the processor 120 executes the plurality of modules 111 (such as the algorithm module 331 shown in FIG. 3), and the algorithm module 331 calculates the current population (such as the initial population) through a plurality of genetic operators to generate corresponding multiple groups.

In the embodiment, the plurality of genetic operators may include, for example, a selection operator, a crossover operator, a mutation operator, and other advanced operators. The selection operator is used to select one or a plurality of groups from the current population (for example, the initial population) based on one or a plurality of selection methods, for example, selecting the group with the greatest fitness value. The crossover operator is used to exchange a plurality of genes of the current population (for example, the initial population) based on one or a plurality of crossover methods. The mutation operator is used to determine whether a plurality of chromosomes of the current population (such as the initial population) are mutated based on a mutation rate.

In step S830, the processor 120 executes the plurality of modules 111 (for example, the algorithm module 331 shown in FIG. 3), and the algorithm module 331 determines whether a current group number reaches a preset number, so as to determine whether to form a new population. When the current group number does not reach the preset number, it means that the current population (for example, the initial population) has not yet completed evolution, and the algorithm module 331 re-executes step S840.

On the other hand, when the current group number reaches the preset number, it means that the current population (for example, the initial population) has completed evolution. At this time, the processor 120 executes step S860. In step S860, the processor 120 executes the plurality of modules 111 (such as the algorithm module 331 shown in FIG. 3), and the algorithm module 331 iterates the current population (such as the initial population) into a secondary population, and proceeds to step S820.

In summary, the inventory optimization device and inventory optimization method of the disclosure may consider various factors affecting inventory through a combined application of genetic programming and genetic algorithm to improve the accuracy of an inventory solution (i.e., the recommendation result), and may continuously optimize the algorithm module according to real-time data and environmental changes (i.e., the business data and parameter data), so as to find the optimal inventory solution. In some embodiments, through interactive operation with the user, the inventory optimization device may adjust the parameters required by the genetic programming and the genetic algorithm according to actual operation conditions of different enterprises, so as to provide a personalized inventory strategy.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. An inventory optimization device, comprising:
a memory, storing a plurality of modules; and
a processor, coupled to the memory, an enterprise database, and an electronic device, and executing the plurality of modules,
wherein the plurality of modules execute genetic programming according to business data from the enterprise database to generate an objective function, calculate the objective function according to an adjustment instruction from the electronic device to generate a fitness function, and execute a genetic algorithm according to the fitness function to generate a recommendation result, so that the electronic device manages the enterprise database according to the recommendation result.

2. The inventory optimization device as claimed in claim 1, wherein the plurality of modules comprise a business module and an algorithm module,
wherein the business module performs a pre-processing operation on the business data to generate operation data,
wherein the algorithm module executes the genetic programming according to algorithm data associated with the genetic programming in the operation data to generate the objective function.

3. The inventory optimization device as claimed in claim 2, wherein the processor accesses a first algorithm database,
wherein the business module stores the operation data in the first algorithm database,
wherein the algorithm module accesses the first algorithm database to obtain the operation data.

4. The inventory optimization device as claimed in claim 3, wherein the processor accesses a second algorithm database,
wherein the algorithm module stores the objective function in the second algorithm database.

5. The inventory optimization device as claimed in claim 2, wherein the plurality of modules further comprise a prediction module and a parameter module,
wherein the prediction module executes a prediction operation according to input parameter data associated with operation of the enterprise database in the operation data to generate parameter data,
wherein the parameter module stores the parameter data in a second algorithm database.

6. The inventory optimization device as claimed in claim 5, wherein the algorithm module accesses the second algorithm database to obtain the parameter data and calculates the objective function according to the parameter data to generate the fitness function.

7. The inventory optimization device as claimed in claim 5, wherein the prediction module performs the prediction operation according to the input parameter data to generate an initial population,
wherein the algorithm module calculates the initial population according to the fitness function so that the initial population is iterated into a secondary population and obtains the recommendation result from the secondary population according to an objective fitness value corresponding to the fitness function.

8. The inventory optimization device as claimed in claim 7, wherein the prediction module performs the prediction operation according to the input parameter data to generate a predicted objective function, and the algorithm module calculates the predicted objective function according to the parameter data to update the fitness function.

9. The inventory optimization device as claimed in claim 8, wherein the plurality of modules further comprise a fitness function module,
wherein the algorithm module calls the fitness function module to CRUD the objective function and the fitness function and calls the parameter module to CRUD the predicted objective function and the initial population.

10. The inventory optimization device as claimed in claim 2, wherein the business module outputs the recommendation result to a user interface of the electronic device, so that the electronic device accesses and displays the recommendation result.

11. An inventory optimization method, wherein executing a plurality of modules in a memory by a processor comprises:
executing genetic programming by the plurality of modules according to business data from an enterprise database to generate an objective function;
calculating the objective function by the plurality of modules according to an adjustment instruction from an electronic device to generate a fitness function; and
executing a genetic algorithm by the plurality of modules according to the fitness function to generate a recommendation result, so that the electronic device manages the enterprise database according to the recommendation result.

12. The inventory optimization method as claimed in claim 11, wherein the plurality of modules comprise a business module and an algorithm module, wherein the step of executing the plurality of modules in the memory further comprises:
performing a pre-processing operation on the business data by the business module to generate operation data; and
executing the genetic programming by the algorithm module according to algorithm data associated with the genetic programming in the operation data to generate the objective function.

13. The inventory optimization method as claimed in claim 12, further comprising:
executing the plurality of modules by the processor to access a first algorithm database, comprising:
storing the operation data in the first algorithm database by the business module; and
accessing the first algorithm database by the algorithm module to obtain the operation data.

14. The inventory optimization method as claimed in claim 13, further comprising:
executing the plurality of modules by the processor to access a second algorithm database, comprising:
storing the objective function in the second algorithm database by the algorithm module.

15. The inventory optimization method as claimed in claim 12, wherein the plurality of modules further comprise a prediction module and a parameter module, wherein the step of executing the plurality of modules in the memory further comprises:
executing a prediction operation by the prediction module according to input parameter data associated with operation of the enterprise database in the operation data to generate parameter data; and
storing the parameter data in a second algorithm database by the parameter module.

16. The inventory optimization method as claimed in claim 15, wherein the step of executing the plurality of modules in the memory further comprises:
accessing the second algorithm database by the algorithm module to obtain the parameter data; and
calculating the objective function by the algorithm module according to the parameter data to generate the fitness function.

17. The inventory optimization method as claimed in claim 15, wherein the step of executing the plurality of modules in the memory further comprises:
performing the prediction operation by the prediction module according to the input parameter data to generate an initial population;
calculating the initial population by the algorithm module according to the fitness function so that the initial population is iterated into a secondary population; and
obtaining the recommendation result by the algorithm module from the secondary population according to an objective fitness value corresponding to the fitness function.

18. The inventory optimization method as claimed in claim 17, wherein the step of executing the plurality of modules in the memory further comprises:
performing the prediction operation by the prediction module according to the input parameter data to generate a predicted objective function; and
calculating the predicted objective function by the algorithm module according to the parameter data to update the fitness function.

19. The inventory optimization method as claimed in claim 18, wherein the plurality of modules further comprise a fitness function module, and the step of executing the plurality of modules in the memory further comprises:
calling the fitness function module by the algorithm module to CRUD the objective function and the fitness function; and
calling the parameter module by the algorithm module to CRUD the predicted objective function and the initial population.

20. The inventory optimization method as claimed in claim 12, wherein the step of executing the plurality of modules in the memory further comprises:
outputting the recommendation result to a user interface of the electronic device by the business module, so that the electronic device accesses and displays the recommendation result.
